(19) United States
(12) Patent Application Publication
(10) Pub. No.: US 2025/0088897 A1
(43) Pub. Date: Mar. 13, 2025

(54) TRAFFIC AWARE POWER SAVING FOR MULTI-LINK DEVICES IN WIRELESS COMMUNICATION SYSTEM

(71) Applicant: Samsung Electronics Co., Ltd., Gyeonggi-do (KR)

(72) Inventors: Yongsen MA, Milpitas, CA (US); Michail KOUNDOURAKIS, Hamburg (DE); Mark Gorthorn RISON, Cambridge (GB); Srinivas KANDALA, Morgan Hill, CA (US); Ravi GIDVANI, Fremont, CA (US)

(21) Appl. No.: 18/819,363

(22) Filed: Aug. 29, 2024

Related U.S. Application Data
(60) Provisional application No. 63/537,730, filed on Sep. 11, 2023.
(60) Provisional application No. 63/591,244, filed on Oct. 18, 2023.
(60) Provisional application No. 63/621,205, filed on Jan. 16, 2024.
(60) Provisional application No. 63/564,286, filed on Mar. 12, 2024.

(51) Int. Cl. H04W 28/02; H04W 28/082; H04W 52/02; H04W 88/10

(52) U.S. Cl. CPC H04W 28/0268; H04W 28/082; H04W 52/0206; H04W 88/10

(57) ABSTRACT

A system and a method are disclosed for improving energy efficiency of an AP MLD utilizing TTLM. A method performed by an AP MLD is provided, which includes establishing, with a non-AP MLD, a first link between a first STA of the non-AP MLD and a first AP of the AP MLD and a second link between a second STA of the non-AP MLD and a second AP of the AP MLD, mapping a plurality of TIDs to the first link and the second link utilizing TTLM; identifying a first event triggering a reduced power operation mode on the second link; and modifying a number of the plurality of TIDs mapped to the second link utilizing the TTLM, in response to identifying the first event.

### CROSS-REFERENCE TO RELATED APPLICATION

This application claims the priority benefit under 35 U.S.C. § 119 (e) of U.S. Provisional Application Nos. 63/537,730, 63/591,244, 63/621,205, and 63/564,286, which were filed on Sep. 11, 2023, Oct. 18, 2023, Jan. 16, 2024, and Mar. 12, 2024, respectively, the disclosure of each of which is incorporated by reference in its entirety as if fully set forth herein.

### TECHNICAL FIELD

The disclosure generally relates to power saving protocols for devices in a wireless communication system. More particularly, the subject matter disclosed herein relates to improvements to energy efficiency of an access point (AP) multi-link device (MLD) utilizing traffic identification (TID)-to-link mapping (TTLM).

### SUMMARY

The Institute of Electrical and Electronics Engineers (IEEE) 802.11be specifies extremely high throughput (EHT) for wireless local area networks (WLANs). EHT allows an AP and a station (STA), i.e., a non-AP MLD, to utilize two or more radios for communications over multiple links.

An AP MLD can utilize two or more radios for communications over multiple links (e.g., radio channels in multiple frequency bands) for transmissions to one or more STAs. An AP MLD can also serve multiple basic service sets (BSSs) that can utilize the multiple links in which the AP MLD operates.

In addition to supporting non-AP MLDs, an AP MLD supports legacy STAs, i.e., non-AP STAs, that expect each BSS to have a unique BSS identification (BSSID) (e.g., a link-specific BSSID) so that discovered BSSs can be listed by BSSIDs.

Multi-link communication can achieve a greater amount of data throughput between MLDs because multiple links can transmit data concurrently. Each link may be associated with a different radio frequency (RF) chain of the MLD, e.g., communication in 2.4 GHz, 5 GHz and 6 GHz frequency bands at the same time, but each RF chain also consumes power when it is activated for multi-link communication. Accordingly, while multi-link operations may increase communication speed, it generally requires more power because multiple links must operate simultaneously.

In view of the foregoing, requirements and recommendations are currently being proposed from standard development organizations, e.g., IEEE, to improve energy efficiency of APs for sustainability purposes, such as meeting net zero and carbon neutral goals.

Existing power saving protocols have been designed mostly for non-AP STAs, but not for APs.

Additionally, the existing protocols and proposals for APs mainly focus on limiting an AP's capability in timing (e.g., target wake time (TWT)), in frequency (e.g., channel bandwidth (BW)), spatially (e.g., number of spatial streams (NSS)), in spatial multiplexing power save (SMPS)), or in power state (active/doze) domains.

Accordingly, an aspect of the present disclosure is to provide protocols and options to improve energy efficiency of APs, mobile APs, soft APs, etc., e.g., by adjusting a traffic/link load, link disablement/enablement, and/or duty cycling for MLDs.

Another aspect of the present disclosure is to utilize and extend current TTLM, as defined by IEEE 802.11be for setup of multi-link operations (MLO) for an MLD, to also support dynamic TTLM patterns and to reduce transition overhead for power saving purposes for AP MLDs.

Another aspect of the of the present disclosure is to provide an AP MLD that can use TTLM for traffic load balancing, link disablement/enablement, and different duty cycling levels. For example, an AP MLD may adjust TTLM based on a number of STAs, buffer status, channel load, traffic load of each TID/link on downlink and uplink, etc.

Another aspect of the of the present disclosure is provide an AP MLD that can use TTLM together with other AP power saving protocols, e.g., adjust settings such as TWT, BW, and NSS.

Another aspect of the of the present disclosure is to provide an AP MLD that can map some TID(s) to certain link(s) to balance traffic load and channel load between different links. For example, an AP MLD can allocate less traffic/TID on certain link(s) and reduce the capability, such as BW and NSS, for the link(s) with low traffic/channel load or low priority. As another example, high volume/priority traffic (e.g., real-time video/gaming) can be mapped to high performance link(s), and low volume/priority traffic (e.g., background and Internet of things (IoT)) can be mapped to links of reduced capability with low BW/NSS. An AP MLD can use suitable resources (e.g., hardware, software, queue, power state, etc.) depending on traffic/TID/channel load and/or priority and to avoid or reduce contentions, collisions, and transitions, thereby improving energy efficiency.

Another aspect of the of the present disclosure is to provide an AP MLD that can map all TIDs to certain link(s) and map no TID to other link(s). For example, an AP MLD can disable certain link(s) for certain duration and enable the link(s) later, or change the duty cycle of certain link(s) by link disablement/enablement. An AP MLD can disable or enable certain link(s) based on certain conditions such as pre-determined schedule, traffic load, and/or channel load. An AP MLD can also use TTLM for cross-link setup and configurations to support cross-link power save options, e.g., sending TTLM on one link to disable or enable other link(s).

In an embodiment, a method is provided for an AP MLD. The method includes establishing, with a non-AP MLD, a first link between a first STA of the non-AP MLD and a first AP of the AP MLD and a second link between a second STA of the non-AP MLD and a second AP of the AP MLD; mapping a plurality of TIDs to the first link and the second link utilizing TTLM; identifying a first event triggering a reduced power operation mode on the second link; and modifying a number of the plurality of TIDs mapped to the second link utilizing the TTLM, in response to identifying the first event.

In an embodiment, an AP MLD is provided, which includes a first AP; a second AP; and a processor configured to establish, with a non-AP MLD, a first link between a first STA of the non-AP MLD and the first AP and a second link between a second STA of the non-AP MLD and the second AP, map a plurality of TIDs to the first link and the second link utilizing TTLM, identify a first event triggering a reduced power operation mode on the second link, and modify a number of the plurality of TIDs mapped to the second link utilizing the TTLM, in response to identifying the first event.

### BRIEF DESCRIPTION OF THE DRAWING

In the following section, the aspects of the subject matter disclosed herein will be described with reference to exemplary embodiments illustrated in the figures, in which:

FIG. 1 illustrates various link states and operation modes of an AP MLD, according to an embodiment;

FIG. 2 illustrates an example of AP MLD load balancing with reduced capability and link disablement/enablement based on traffic/link load, according to an embodiment;

FIG. 3 illustrates an example of AP MLD link disablement for MLD user data, while maintaining management operations, according to an embodiment;

FIG. 4 illustrates an example of duty cycling by link disablement/enablement, according to an embodiment;

FIG. 5 illustrates an example of duty cycling by traffic/TID load balancing and reduced capability, according to an embodiment;

FIG. 6 is a flow chart illustrating a method performed by an AP MLD, according to an embodiment;

FIG. 7 is a block diagram of an electronic device in a network environment, according to an embodiment; and

FIG. 8 shows a system including an AP MLD and a non-AP MLDin communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In accordance with an embodiment of the disclosure, power save protocols are provided, which may be used to adjust TTLM based on various conditions, such as traffic load and channel load, for traffic load balancing, for link disabling/enabling, and for duty cycling.

In accordance with an embodiment of the disclosure, options are provided to extend TTLM to support dynamic patterns and to reduce transition overhead. That is, TTLM may be utilized to support different operation modes and processes for improving the energy efficiency of AP MLDs.

### AP MLD and Non-AP STA Operations

An AP MLD can initiate TTLM and advertise the TTLM to STAs. Non-AP STAs can negotiate a TTLM with the AP MLD and can take proper actions based on the current/future TTLM.

According to an embodiment, an AP MLD may have an operation mode in which a link is disabled for user data (i.e., no TID is mapped to the link), while management type operations may still be enabled on the link. For example, although the link is disabled for user data, the AP MLD may still transmit beacons and respond to probe request on the link, unless in a doze state.

An AP MLD may allow a non-AP MLD to indicate which link it uses for management operations like beacon reception, so that the AP MLD will knows if it should continue beaconing or if can stop beaconing when TTLM has disabled the link for all the STAs.

An AP MLD can also utilize TTLM together with other AP power save protocols/options. For example, the AP MLD can gradually shift the traffic/TID load from one link to another link, and the link with a reduced traffic/TID load can then send an operating mode notification (OMN), reduce the BW/NSS, or enter into a doze state.

In accordance with an embodiment of the disclosure, a power save protocol can be used in different scenarios and be adaptive to different conditions such as manual schedule, automatic schedule based on traffic load, channel load or other conditions, and intelligently switch in different modes.

In accordance with an embodiment of the disclosure, a power save protocol can extend the TTLM to support dynamic patterns and to reduce transition overhead.

For example, to support periodic/predictable/dynamic patterns, subfields may be added, such as interval, persistence, and count information.

The AP MLD can adjust the TTLM dynamically, and non-AP STAs can know the TTLM pattern and the AP's link/power state in advance and take actions accordingly, e.g., a power save mode, a probe request, a multi-link (re) setup.

In accordance with an embodiment of the disclosure, to reduce transition overhead, subfields may also be added for simplified BSS/MLD operations for link disablement/enablement.

Examples of subfield addition/modification are provided below in Table 1 and 2.

TABLE 1
TID-To-Link Mapping Control field format

| | | | | | | | | Link |
|---|---|---|---|---|---|---|---|---|
| | | | Mapping | | | | | Mapping |
| | | Default | Switch | Expected | Link | | | Presence |
| | | Link | Time | Duration | Mapping | | Extension | Bitmap |
| | Direction | Mapping | Present | Present | Size | Reserved | Indication | (Optional) |
| Bits: | 2 | 1 | 1 | 1 | 1 | 1 | 1 | 0 or 8 |

TABLE 2
TID-To-Link Mapping Extension field format

| | | | | | TTLM | | |
|---|---|---|---|---|---|---|---|
| | TTLM | | | | Stop | | |
| | Extension | TTLM | TTLM | TTLM | Count/ | TTLM | |
| | Control | ID | Unit | Interval | Time | Mode | . . . |
| Bits: | TBD | TBD | TBD | TBD | TBD | TBD | . . . |

Table 1 above is a modification of a TID-To-Link Mapping element format in clause 9.4.2.324 of IEEE P802.11be. In this example, the two bolded subfields (i.e., Reserved and Extension Indication) are modified. When the Extension Indication subfield is 1, this indicates that the TID-To-Link Mapping Extension field as shown in Table 2 is present.

In Table 2, the bolded subfields (i.e., TTLM Unit, TTLM Interval, TTLM Stop Count/Time) are added.

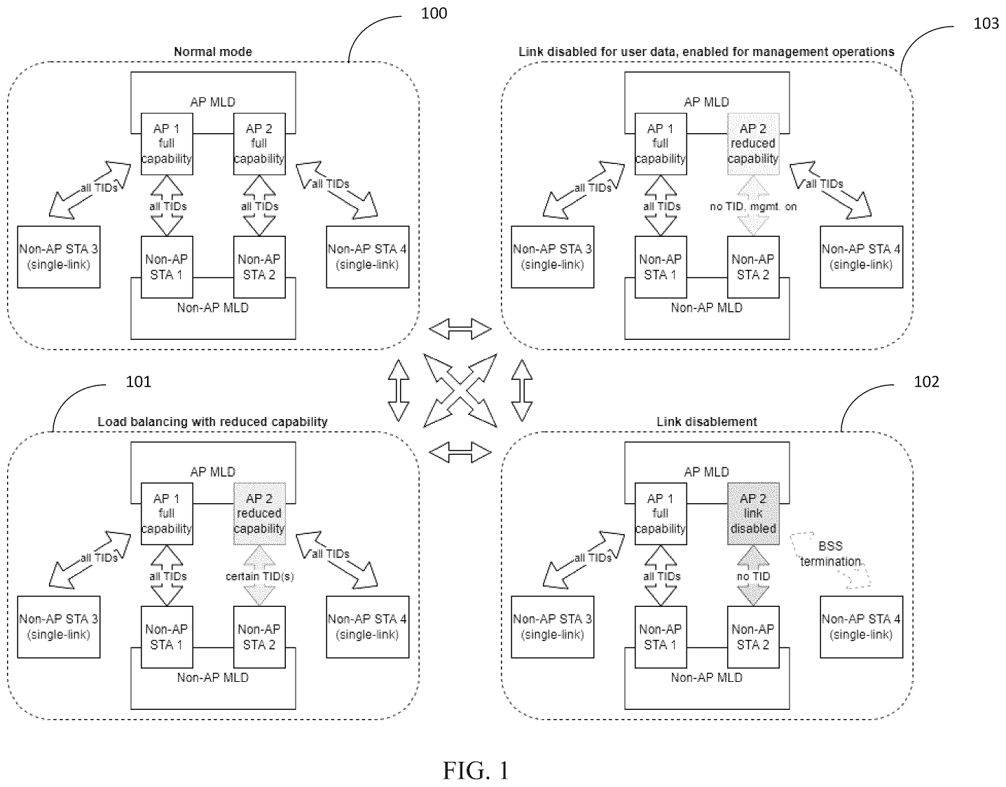

FIG. 1 illustrates various link states and operation modes of an AP MLD, according to an embodiment.

Referring to FIG. 1, in a normal operation mode 100, a WLAN may be formed by an AP MLD that provides a shared wireless communication medium for use by a number of STAs. In the example of FIG. 1, the STAs include a non-AP STA 1 and a non-AP STA 2, which are included in a non-AP MLD, and single link non-AP STAs 3 and 4. The basic building block of a WLAN conforming to the IEEE 802.11 family of standards is a BSS, which is managed by the AP MLD, and each BSS is identified by a BSSID that is advertised by the AP MLD. For example, the AP MLD periodically broadcasts beacon frames so that the non-AP STAs 1-4, which are within wireless range of the AP MLD can establish an association with the WLAN.

A STA may have a wireless connection after it has authenticated and established a wireless session with the AP MLD.

Further, the devices in a WLAN may share control information to maintain or share status.

For example, the AP MLD may operate a first BSS in a first frequency band and a second BSS in a second frequency band. The AP MLD and the non-AP MLD may establish a multi-link association in which multiple links are enabled between the AP MLD and the non-AP MLD. Each link of the multi-link association may be between a different STA interface of the non-AP MLD in a corresponding BSS of the AP MLD.

In FIG. 1, for example, the non-AP MLD establishes a first link to the first BSS using non-AP STA 1 of the non-AP MLD and establishes a second link to the second BSS using the non-AP STA 2 of the non-AP MLD. The multiple links of the multi-link association may be established using different channels, frequency bands, or spatial streams, among other examples.

The AP MLD and the non-AP MLD may exchange setup and response frames via a first link to provision or configure multiple links of the multi-link association. The multi-link setup via the first link may enable the non-AP STAs 1 and 2 of the non-AP MLD to concurrently associate with the different BSSs operated by the AP MLD.

When the AP MLD and the non-AP MLD establish a multi-link association, one or more TIDs may be mapped to one or more links established by the multi-link association. In the example of FIG. 1, in the normal operation mode 100, all TIDs are amend to all links.

However, while multi-link operations may increase communication speed, it generally requires more power because the multiple links must operate simultaneously.

In view of the foregoing, in accordance with an embodiment of the disclosure, a traffic aware power save protocol may be provided for an AP MLD utilizing TTLM. More specifically, the AP MLD may use TTLM for traffic load balancing, link disablement/enablement, and different duty cycling levels. The AP MLD may adjust the TTLM and operating mode, e.g., based on number of STAs, buffer status, pre-determined schedule, channel load, traffic load of each TID/link on a downlink and/or uplink, etc., thereby reducing power consumption.

In the example of FIG. 1, AP 1 (or link 1) of the AP MLD is always operating in full capability with all TIDs mapped, and AP 2 (or link 2) of the AP MLD may operate in full capability (e.g., in normal operation mode 100), in reduced capability, with all TIDs mapped thereto, with selected TID(s) mapped thereto, with no TID mapped thereto, with the link disabled for user data but still enabled for management operations, and/or with no TID mapped thereto and with the link completely disabled. However, it is noted the present disclosure is not limited to this example, e.g., AP 2 may always operate in full capability with all TIDs mapped, and AP 1 may have different operation modes, or both AP 1 and AP 2 may have different operation modes.

In operation mode 101 for load balancing with reduced capability, the AP MLD maps certain TID(s), i.e., not all of the TIDs, to link 2 in order to balance the traffic load and channel load for the different links. That is, the AP MLD may allocate less traffic/TIDs on certain link(s) and reduce the operating capability, such as BW and NSS, for links with low traffic/channel load or low priority. As another example, high volume/priority traffic (e.g., real-time video/gaming) can be mapped to high performance link(s), and low volume/priority traffic (e.g., background and IoT) can be mapped to links of reduced capability with low BW/NSS. The AP MLD can use suitable resources (e.g., hardware, software, queue, power state, etc.) depending on traffic/TID/channel load and/or priority and to avoid or reduce contentions, collisions, and transitions, thereby improving energy efficiency.

In operation mode 102 with link disablement, the AP MLD maps all TIDs to link 1 and maps no TIDs to link 2. That is, the AP MLD may disable certain link(s) for certain duration and enable the link(s) at a later time, and/or change duty cycling levels by link disablement/enablement. The AP MLD can disable or enable certain link(s) based on certain conditions such as pre-determined schedule, traffic load, channel load, etc. The AP MLD can also use TTLM for cross-link setup and configurations to support cross-link power save options, e.g., sending TTLM on one link to disable or enable other link(s).

Non-AP STAs that know the AP MLD's TTLM and operating mode may take actions accordingly.

In operation mode 103 with link disablement for user data, but with enablement for management operations, the AP MLD the AP MLD maps all TIDs to link 1 and maps no TIDs to link 2, but maintains management operations, e.g., continues to transmit beacons and probe responses, on link 2.

The non-AP MLD and the AP MLD may negotiate/indicate the operation mode on certain links. Additionally, the AP MLD may use TTLM for cross-link setup and configurations to support cross-link power save options, e.g., sending TTLM on link 1 to disable or enable link 2. The AP MLD may also use TTLM together with other AP power save protocols, e.g., adjust settings such as TWT, BW, and NSS.

Each of the operation modes 101, 102, and 103 may be referred to as a reduced power operation mode.

As illustrated in FIG. 1, the AP MLD may freely transition between the different operation modes and/or with different duty cycling levels, e.g., based on number of STAs, buffer status, pre-determined schedule, channel load, traffic load of each TID/link on a downlink and/or uplink, thereby reducing power consumption.

As described d above, existing TTLM may be extended to support periodic/predictable/dynamic TTLM patterns, e.g., as shown in Table 2 above, to reduce transition overhead for link disablement/enablement, to support flexible duty cycling levels, and to add new modes such as operation mode 103, wherein a link disabled for user data, but enabled for management operations and cross-link operations.

Based on the foregoing, different options for AP MLD power saving are provided by adjusting TTLM and operating mode. For example, the TTLM can be set such that high volume traffic (e.g., real-time video/gaming) is transmitted on a high performance link, and low volume traffic (e.g., background and IoT) is transmitted on a link with reduced capability (low BW/NSS)

The AP MLD and the non-AP MLD may negotiate a new TTLM to support switching of the links.

To support non-AP MLDs/STAs that do not operate on all bands (including to support coexistence), a non-AP MLD/STA may select certain link(s) for transmission/reception. The AP MLD may determine to continue or stop beaconing based on the non-AP MLD/STA's selection.

The AP MLD may adjust the TTLM dynamically, and a non-AP MLD may know the TTLM pattern and the AP MLD's link/power state in advance and take actions accordingly, e.g., power save mode, probe request, multi-link (re) setup.

The AP MLD may quickly switch certain link(s) between enabled and disabled, which may reduce transition overhead in terms of BSS transition/termination, (dis/re) association, multi-link (re) setup, etc.

The AP MLD may gradually shift a traffic/TID load from one link to another link, and the link with reduced traffic/TID load can reduce the BW/NSS or enter into a doze state.

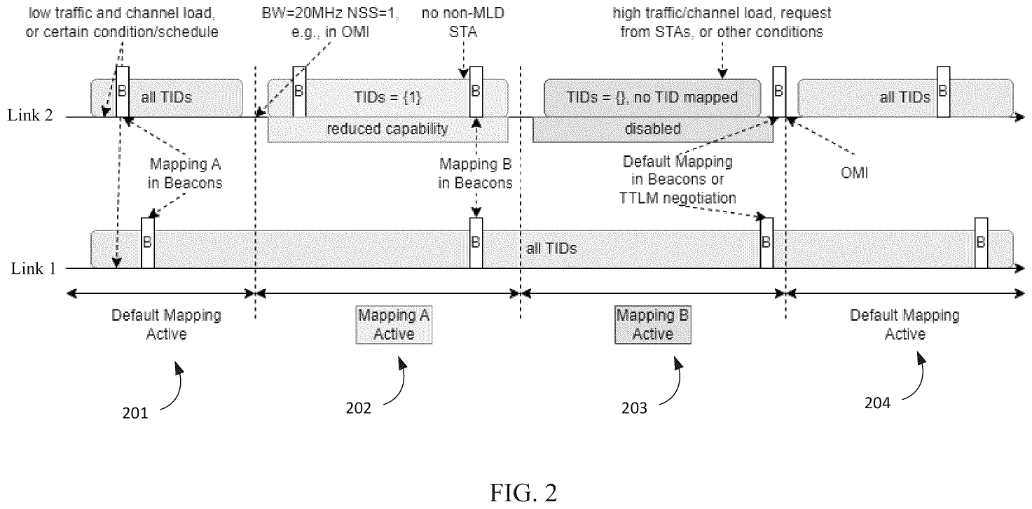

FIG. 2 illustrates an example of AP MLD load balancing with reduced capability and link disablement/enablement based on traffic/link load, according to an embodiment. For example, the operation illustrated in FIG. 2 may correspond to operation modes 100, 101, and 102 as illustrated in FIG. 1.

Referring to FIG. 2, at stage 201, while a default mapping is active (e.g., corresponding to operation mode 100), the AP MLD identifies an event triggering a reduced capability mode (e.g., low traffic and/or channel load, e.g., below a certain threshold, a certain condition, a scheduled event, etc.), i.e., a reduced power operation mode, and then transmits beacons on links 1 and 2 to inform the corresponding STAs of a transition to mapping A. For example, the beacons include an operating mode indication (OMI).

At stage 202, with mapping A active (e.g., corresponding to operation mode 101), the AP MLD reduces the capacity of link 2, mapping only TID {1} thereto, while maintaining all TIDs on link 1.

Thereafter, the AP MLD then identifies that there are no non-MLD STAs receiving link 2, i.e., identifies an event triggering a modification of the reduced power operation mode, and in response, transmits beacons on links 1 and 2 to inform the corresponding STAs of a transition to mapping B.

At stage 203, with mapping B active (e.g., corresponding to operation mode 102), the AP MLD disables link 2, mapping no TID thereto, while maintaining all TIDs on link 1.

Thereafter, the AP MLD identifies an event triggering a return to the normal operation mode, e.g., a high traffic and channel load (e.g., above a certain threshold), a request from an STA, or other conditions triggering the enablement of link 2. In response, the AP MLD transmits beacons on links 1 and 2 to inform the corresponding STAs of a transition to the default mapping.

At stage 204, when the default mapping is active (e.g., corresponding to operation mode 100), all TIDs are mapped to each of links 1 and 2.

Although FIG. 2 illustrates the mapping transitions occurring through beacons, these transmission may also be performed through TTLM negotiation between the AP MLD and the non-AP STAs.

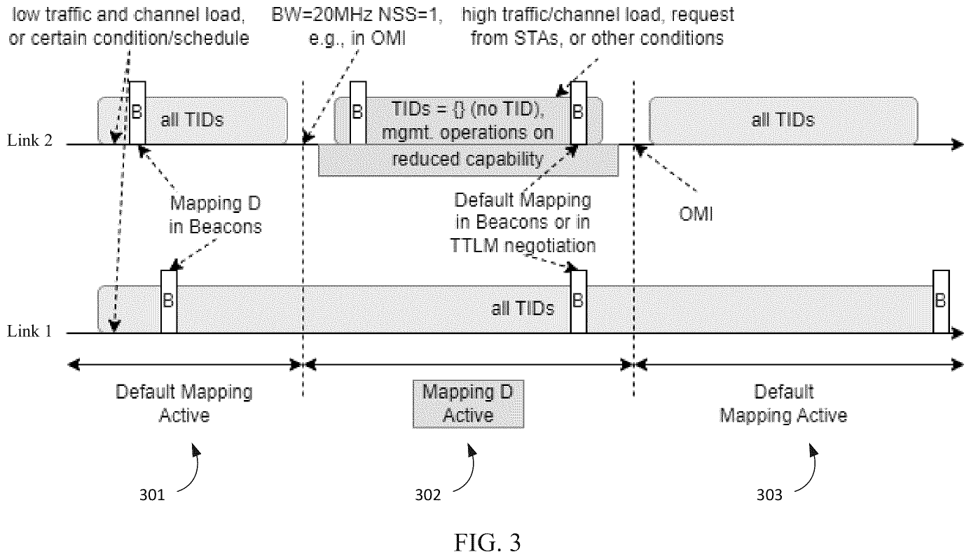

FIG. 3 illustrates an example of AP MLD link disablement for MLD user data, while maintaining management operations, according to an embodiment. For example, the operation illustrated in FIG. 3 may correspond to operation modes 100 and 103 as illustrated in FIG. 1.

Referring to FIG. 3, at stage 301, while a default mapping is active (e.g., corresponding to operation mode 100), the AP MLD identifies an event triggering a reduced capability mode (e.g., low traffic and/or channel load, e.g., below a certain threshold, a certain condition, a scheduled event, etc.), and then transmits beacons on links 1 and 2 to inform the corresponding STAs of a transition to mapping D.

At stage 302, with mapping D active (e.g., corresponding to operation mode 103), the AP MLD reduces the capacity of link 2, mapping no TID thereto, but maintaining management operations on link 2, and maintaining all TIDs on link 1.

Thereafter, the AP MLD then identifies an event triggering a return to the normal operation mode, e.g., a high traffic and channel load (e.g., above a certain threshold), a request from an STA, or other conditions triggering the enablement of link 2. In response, the AP MLD transmits beacons on links 1 and 2 to inform the corresponding STAs of a transition to the default mapping.

At stage 303, the default mapping is active (e.g., corresponding to operation mode 100) and all TIDs are mapped to each of links 1 and 2.

Although FIG. 3 illustrates the mapping transitions occurring through beacons, these transmission may also be performed through TTLM negotiation between the AP MLD and the non-AP STAs.

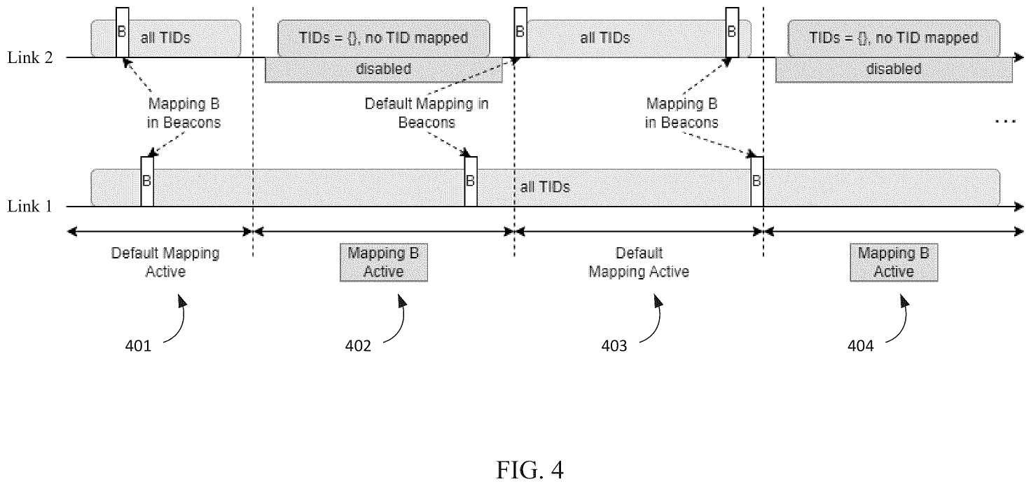

FIG. 4 illustrates an example of duty cycling by link disablement/enablement, according to an embodiment. For example, the operation illustrated in FIG. 4 may correspond to operation modes 100 and 102 as illustrated in FIG. 1.

Referring to FIG. 4, at stage 401, while a default mapping is active (e.g., corresponding to operation mode 100), the AP MLD transmits beacons on links 1 and 2 to inform the corresponding STAs of a transition to mapping B (e.g., corresponding to operation mode 102) after a predetermined interval or at a designated time.

At stage 402, after the predetermined interval or at the designated time, the AP MLD disables link 2, mapping no TID thereto, while maintaining all TIDs on link 1.

The AP MLD then transmits beacons on links 1 and 2 to inform the corresponding STAs of a transition to back to the default mapping, after a predetermined interval or at a designated time.

At stage 403, after the predetermined interval or at the designated time, the AP MLD enables link 2, mapping all TID thereto, while maintaining all TIDs on link 1.

At stage 404, the process repeats, wherein the AP MLD disables link 2, mapping no TID thereto, while maintaining all TIDs on link 1, after a predetermined interval or at a designated time indicated in beacons transmitted at stage 403.

As described above, the AP MLD may duty cycle between the normal operation mode 100 and the operation mode 102 as illustrated in FIG. 1.

Although FIG. 4 illustrates the mapping transitions occurring through beacons, these transmission may also be performed through TTLM negotiation between the AP MLD and the non-AP STAs.

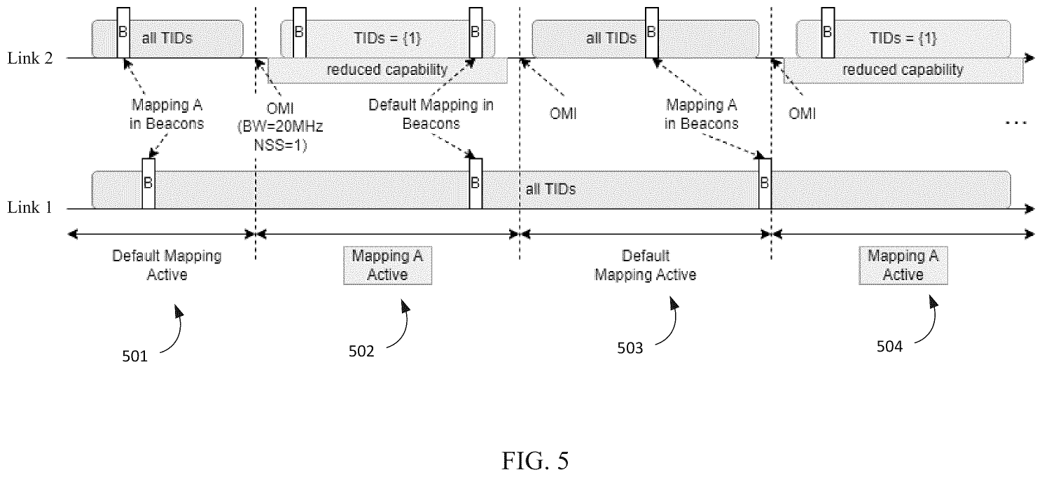

FIG. 5 illustrates an example of duty cycling by traffic/TID load balancing and reduced capability, according to an embodiment. For example, the operation illustrated in FIG. 5 may correspond to operation modes 100 and 101 as illustrated in FIG. 1.

Referring to FIG. 5, at stage 501, while a default mapping is active (e.g., corresponding to operation mode 100), the AP MLD transmits beacons on links 1 and 2 to inform the corresponding STAs of a transition to mapping A (e.g., corresponding to operation mode 101) after a predetermined interval or at a designated time.

At stage 502, after the predetermined interval or at the designated time, the AP MLD transitions to mapping A, and reduces the capacity of link 2, e.g., mapping only TID {1} thereto, while maintaining all TIDs on link 1.

The AP MLD then transmits beacons on links 1 and 2 to inform the corresponding STAs of a transition to back to the default mapping, after a predetermined interval or at a designated time.

At stage 503, after the predetermined interval or at the designated time, the AP MLD enables link 2, mapping all TID thereto, while maintaining all TIDs on link 1.

At stage 504, the process repeats, wherein the AP MLD reduces the capacity of link 2, e.g., mapping only TID {1} thereto, while maintaining all TIDs on link 1, after a predetermined interval or at a designated time indicated in beacons transmitted at stage 503.

As described above, the AP MLD may duty cycle between the normal operation mode 100 and the operation mode 101 as illustrated in FIG. 1.

Although FIG. 5 illustrates the mapping transitions occurring through beacons, these transmission may also be performed through TTLM negotiation between the AP MLD and the non-AP STAs.

Although FIGS. 4 and 5 illustrate examples of duty cycling between operations 100 and 102 and between operations 100 and 101, respectively, the disclosure is not limited thereto. For example, an AP MLD may duty cycle between operations 100 and 103 in a similar manner.

Although FIGS. 1-5 have been described above with reference to a multi-link session between an AP MLD and a non-AP MLD including two links (i.e., link 1 and link 2), the disclosure is not limited to this example. The above-described embodiments are also applicable to multi-link sessions including more than two links.

For example, when a multi-link session between an AP MLD and a non-AP MLD including four links, operation mode modes 101 to 103 may include reducing capacity or disabling one, two, or three of the links, while maintaining all TIDs in the non-reduced/disabled links.

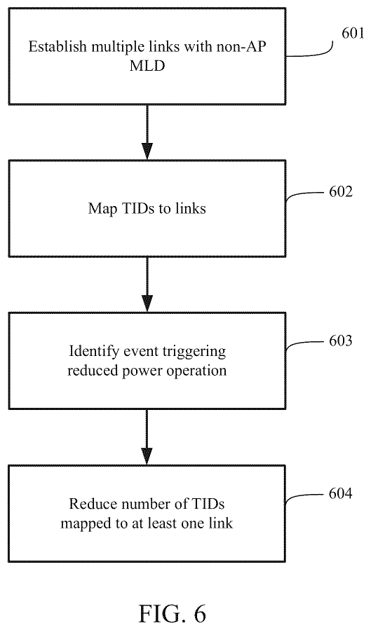

FIG. 6 is a flow chart illustrating a method performed by an AP MLD, according to an embodiment.

Referring to FIG. 6, in step 601, the AP MLD establishes multiple links with a non-AP MLD. For example, as illustrated in operation mode 100 of FIG. 1, the AP MLD establishes a first link between a first STA of the non-AP MLD and a first AP of the AP MLD and a second link between a second STA of the non-AP MLD and a second AP of the AP MLD.

In step 602, the AP MLD maps TIDs to the established links. For example, referring again to operation mode 100 of FIG. 1, the AP MLD maps all TIDs to each of the first link and the second link utilizing TTLM.

In step 603, the AP MLD identifies an event triggering a reduced power operation mode. For example, the AP MLD may identify a traffic or channel load below a threshold, or a duty cycle interval.

In step 604, in response to identifying the event, the AP MLD enters into a reduced power operation mode by modifying a number of the TIDs mapped to at least one of the established links. For example, referring again to FIG. 1, the AP MLD may reduce the number of TIDs mapped to the second link in operation mode 101, 102, or 103.

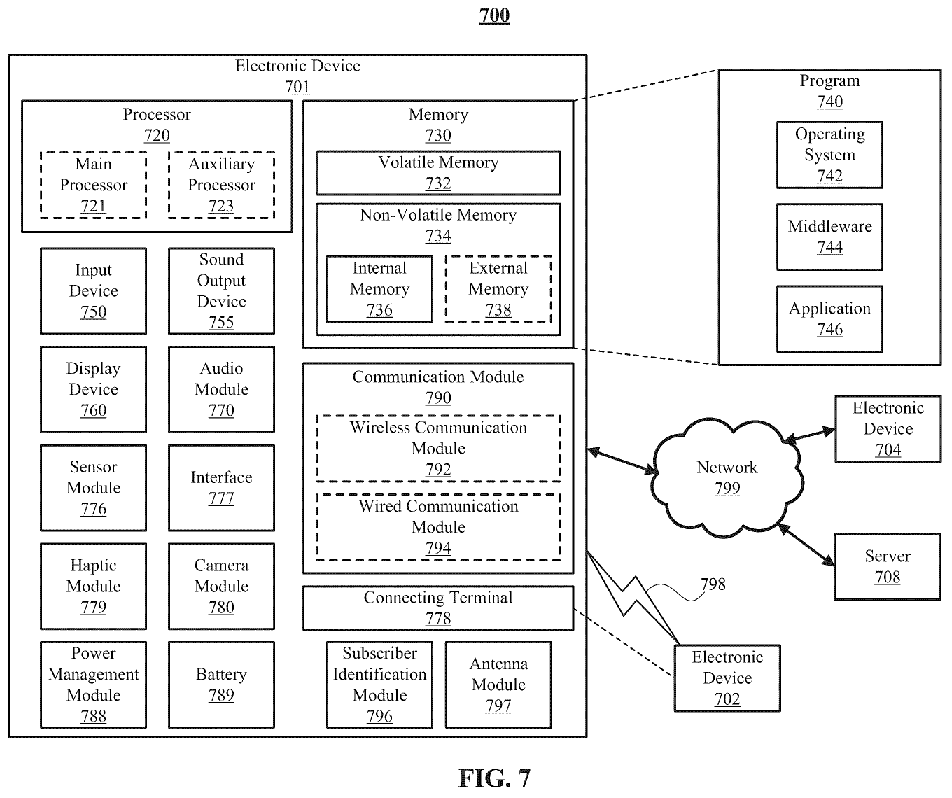

FIG. 7 is a block diagram of an electronic device in a network environment 700, according to an embodiment.

Referring to FIG. 7, an electronic device 701 (e.g., an AP MLD, a non-AP MLD, or a non-AP STA) in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations. For example, the processor 720 may execute software to control the electronic device 701 to perform the method illustrated in FIG. 6.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

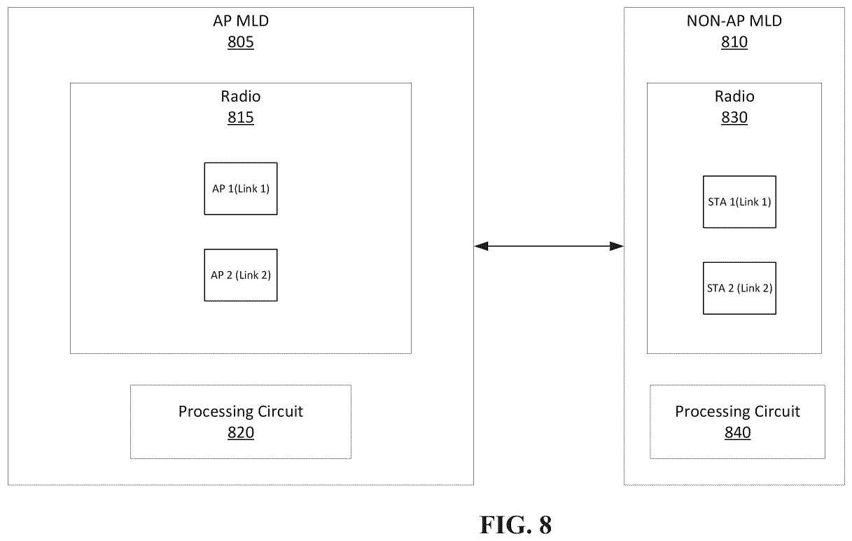

FIG. 8 shows a system including an AP MLD 805 and a non-AP MLD 810, in communication with each other. The AP MLD 805 may include a radio 815 and a processing circuit (or a means for processing) 820, which may perform various methods disclosed herein, e.g., the method illustrated in FIG. 6. For example, the processing circuit 820 may transmit and receive, via the radio 815, over multiple links (AP1, AP2, etc.), signals to and from the non-AP MLD 810. Similarly, the non-AP MLD 810 may include a processing circuit 840 that may transmit and receive, via a radio 830, over multiple links (STA1, STA2, etc.), signals to and from the AP MLD 805.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination.

Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by an access point (AP) multi-link device (MLD), the method comprising:
establishing, with a non-AP MLD, a first link between a first station (STA) of the non-AP MLD and a first AP of the AP MLD and a second link between a second STA of the non-AP MLD and a second AP of the AP MLD;
mapping a plurality of traffic identifications (TIDs) to the first link and the second link utilizing TID-to-link mapping (TTLM);
identifying a first event triggering a reduced power operation mode on the second link; and
modifying a number of the plurality of TIDs mapped to the second link utilizing the TTLM, in response to identifying the first event.

2. The method of claim 1, wherein modifying the number of the plurality of TIDs mapped to the second link comprises:
selecting certain TIDs from among the plurality of TIDs that balance traffic or channel loads of the first and second links; and
mapping the certain TIDs to the second link utilizing the TTLM.

3. The method of claim 1, wherein modifying the number of the plurality of TIDs mapped to the second link comprises:
mapping none of the plurality of TIDs to the second link; and
disabling the second link.

4. The method of claim 1, wherein modifying the number of the plurality of TIDs mapped to the second link comprises:
mapping none of the plurality of TIDs to the second link; and
maintaining management operations on the second link.

5. The method of claim 4, wherein maintaining management operations on the second link comprises transmitting at least one of a beacon or a probe response on the second link.

6. The method of claim 1, further comprising:
identifying a second event triggering a modification of the modified power operation mode on the second link; and
re-modifying the modified number of the plurality of TIDs mapped to the second link utilizing the TTLM, in response to identifying the second event.

7. The method of claim 6, wherein identifying the second event triggering the modification of the reduced power operation mode comprises identifying that no non-MLD STAs receive the second link.

8. The method of claim 1, further comprising:
identifying a second event triggering an end to the reduced power operation mode on the second link; and
re-mapping the plurality of TIDs to the second link utilizing the TTLM, in response to identifying the second event.

9. The method of claim 8, wherein identifying the second event triggering an end to the reduced power operation mode comprises at least one of:
identifying a traffic or channel load above a threshold;
identifying a duty cycle interval; or
receiving a request from an STA.

10. The method of claim 1, wherein identifying the first event triggering the reduced power operation mode comprises at least one of:
identifying a traffic or channel load below a threshold; or
identifying a duty cycle interval.

11. The method of claim 1, further comprising maintaining the number of the plurality of TIDs mapped to the first link, in response to identifying the first event.

12. The method of claim 1, further comprising transmitting, to the non-AP MLD, a beacon indicating a transition to the reduced power operation mode.

13. The method of claim 12, wherein the beacon is transmitted on the first link.

14. An access point (AP) multi-link device (MLD), comprising:
a first AP;
a second AP; and
a processor configured to:
establish, with a non-AP MLD, a first link between a first station (STA) of the non-AP MLD and the first AP and a second link between a second STA of the non-AP MLD and the second AP,
map a plurality of traffic identifications (TIDs) to the first link and the second link utilizing TID-to-link mapping (TTLM),
identify a first event triggering a reduced power operation mode on the second link, and
modify a number of the plurality of TIDs mapped to the second link utilizing the TTLM, in response to identifying the first event.

15. The AP MLD of claim 14, wherein the processor is further configure to modify the number of the plurality of TIDs mapped to the second link by:
selecting certain TIDs from among the plurality of TIDs that balance traffic or channel loads of the first and second links; and
mapping the certain TIDs to the second link utilizing the TTLM.

16. The AP MLD of claim 14, wherein the processor is further configure to modify the number of the plurality of TIDs mapped to the second link by:
mapping none of the plurality of TIDs to the second link; and
disabling the second link.

17. The AP MLD of claim 14, wherein the processor is further configure to modify the number of the plurality of TIDs mapped to the second link by:
mapping none of the plurality of TIDs to the second link; and
maintaining management operations on the second link.

18. The AP MLD of claim 17, wherein the processor is further configure to maintain the management operations on the second link by transmitting at least one of a beacon or a probe response on the second link.

19. The AP MLD of claim 14, wherein the processor is further configure to:
identify a second event triggering a modification of the reduced power operation mode on the second link, and
re-modify the modified number of the plurality of TIDs mapped to the second link utilizing the TTLM, in response to identifying the second event.

20. The AP MLD of claim 14, wherein the processor is further configure to maintain the number of the plurality of TIDs mapped to the first link, in response to identifying the first event.
